(19) United States
(12) Patent Application Publication
(10) Pub. No.: US 2008/0140708 A1
(43) Pub. Date: Jun. 12, 2008

(54) System and method for providing a computer aided medical diagnostic over a network

(76) Inventors: Oren Fuerst, New York, NY (US); Tzameret Fuerst, New York, NY (US)

Correspondence Address: Eugene Lieberstein;ANDERSON KILL & OLICK, P.C., 1251 Avenue of the Americas, New York, NY, 10020, US

(21) Appl. No.: 10/355,091

(22) Filed: Jan. 31, 2003

Related U.S. Application Data
(60) Provisional application No. 60/352,566, filed on Jan. 31, 2002.

(51) Int. Cl. G06F 17/30

(52) U.S. Cl. 707/104.1; 707/E17.019

(57) ABSTRACT

The present invention relates to a method for improving the quality of diagnosis accuracy of diseases using remote analysis of images. Data including a medical image is being sent to a data center where an analysis is conducted to compare the digital image and additional information with a data base that includes the characteristics of a suspected image, based on a learning path of previously diagnoses maligned and benign images. A predictive probability is the result of the process, and is being sent to the patient and to his or her healthcare provider.

Predictive probabilities are then compared over time with actual results over time and are being used to improve the algorithms providing the predictive probabilities.

### CROSS-REFERENCE TO RELATED APPLICATIONS

This patent application is claiming the benefit of prior filed provisional patent application 60/352,566, with filing date Jan. 31, 2002.

### FIELD OF THE INVENTION

The present invention relates generally to computer-aided medical diagnostic, more particularly to conducting, over an electronic network such as the Internet, the transmission of medical information including information such as digital images, mainly skin images, additional patient information and the computer-aided analysis and diagnostic of diseases.

### SUMMARY

A computer system and method for providing a computer aided or automated medical diagnostic of disease utilizing medical information that includes information such as images and answers to template-based questionnaires over a network is disclosed. An embodiment of the invention provides a computer software to determine the probability of a patient having a disease, based on information such as the patient's digital image, historical digital images of the patient and of other patient, additional patient-specific information entered by providers in response to computerized questionnaires or using natural language, as well as external information describing the environment. Such environmental information can include information regarding the historical and present prevalence of the described disease.

In accordance with the present invention, information such as an image of a skin lesion, coupled with additional answers entered by the medical provider can assist in characterizing the patients having an infectious disease such as smallpox. This is done by correlating the patient specific information, with historic and current information, both patient specific, as well environment related, as to determine the probability of a patient to have a disease.

The combination of an automated digital imaging analysis, with the analysis of additional patient-specific information and environmental information regarding the history and current prevalence of diseases at that time and location is enhancing the accuracy, speed and cost effectiveness of diagnosing diseases. That improvement is crucial in particular in situations where infectious diseases are suspected to be prevalent, either naturally, or man-induced (biological warfare). The connectivity of the program provides fir the ability to continuously refine and calibrate the system, an essential advantage over fixed diagnostic tools.

The forecasts is then reported and stored for future reference. The information is verified against a diagnostic by medical experts, and the comparison of the results are entered to the system, to further enhance the model's accuracy. Similarly, future information regarding the patient health is stored and compared to the model forecasts.

### BACKGROUND

A rapid analysis of diseases is essential. For example, biological Warfare is an area where special and advanced diagnostics is required. The Department of Defense (DOD) reports¹ that an attack with a biological agent may occur without warning, and that the first indication that an attack has occurred may be the appearance of sick patients, often with the same initial symptoms. Immediate diagnosis, is essential for effective response. ¹http://www.darpa.mil/dso/thrust/bwd/mc_2.htm

The same symptoms may also be caused by a variety of natural infections, which will need to be differentiated, and a hence an efficient tool for rapid diagnostics, utilizing multiple sources of information is essential. In addition, as biological attack can occur in virtually any locale, it is essential the diagnostic platform can be mobile.

Furthermore, existing methods for disease identification commonly require highly specialized skilled medical professionals and may take days to be completed, potentially causing disastrous delays in responding appropriately to the threat or to the possibility of inappropriate action based on inadequate information. Therefore, a rapid diagnostic tool that has many automated functions is useful for the rapid diagnostic of disease by the medical professionals and patients that are not necessarily skilled in disease diagnostic.

In addition, a networked diagnostic platform is essential, as it allows for connection to external surveillance tools. Government authorities had suggested repeatedly that biological warfare attack could go unnoticed². Surveillance for covert biological warfare and biological terrorist activities is needed to counter the ²http://www.darpa.mil/ito/research/rkfbio/index.html threat. If an event occurs, surveillance is needed to identify the presence of the pathogen or the initial indicators of disease as soon as possible so that a rapid response can be implemented.

The automated procedure of analyzing the picture could utilize automated versions of known manual algorithms used by epidemiologists and dermatologists, as well utilizing algorithms that are data intensive and hence unfeasible for manual analysis. For example, P. Carli, V. De Giorgi, H. P. Soyer, M. Stante and B. Giannotti³ and others report that studies indicate that, a high rate of diagnostic accuracy of pigmented skin lesions is obtained only if the diagnostic is performed by dermatologists with a long experience in the field or, if formally trained for this technique. Therefore, new diagnostic algorithms, for example the manual methodology termed “ABCD rule of dermatoscopy” for diagnosing melanoma (examining asymmetry, the borders, the colour and the different dermascopic structure) were developed in order to increase the diagnostic accuracy by non-experienced ELM investigators. However, these techniques, involve manual scoring by the medical professional, and hence are both time and resource intensive, and involve discretion of the medical professional. A computerized algorithm that analyzes the image in an automated fashion should be both more objective, accurate, quicker and more cost efficient. Adding to the automated analysis of additional patient-specific and environment information could further enhance the accuracy and reliability of the system. ³P. Carli, V. De Giorgi, H. P. Soyer, M. Stante and B. Giannotti reports that Epiluminescence microscopy in the management of pigmented skin lesions

The data is examined in light of the environment information, which influences the probabilities of the patient to have the disease, given the same symptoms. For example, the Center of Disease Control (CDC) describes that the symptoms of flu and anthrax can be similar. However, they suggest that a runny nose is a rare feature of anthrax. And hence a person who has a runny nose along with other common influenza-like symptoms, or a high prevalence of people with runny noise at the same time, might be an indication that this is the common cold than to have anthrax.

Examining multiple sources of information could be essential for distinguishing between biological agents and common flu. For example, chest X-rays or CT showed that all patients with inhalational anthrax have some abnormality, although for some patients, the abnormality was subtle.

Furthermore, information obtained from a plurality of sources is useful in deriving predictive probabilities of a patient to develop or to have certain diseases. For example, those who have dysplastic nevi and a family history of dysplastic nevi and melanoma have more than a 50% risk of developing melanoma by the age of 60. Others who have dysplastic nevi but not such a strong family history of melanoma have an estimated lifetime risk of melanoma of 6%.

In some of the patients infected by Anthrax during the October-November 2001 periods, Lesions occurred on the forearm, neck, chest, and fingers. Lesions were painless but accompanied by a tingling sensation. Diagnosis was established by biopsy or culture, a process that took more than a day. A computerized diagnosis based on images provides a more rapid response at time of emergency, and allows for more large scales testing.

A rapid and automated mechanism of distinguishing diseases is essential for highly contagious and lethal diseases such as smallpox. Professor Henderson⁴ reports that the disease most commonly confused with smallpox is chickenpox, and during the first 2 to 3 days of rash, it may be all but impossible to distinguish between the two. Therefore, any medical provider, and in particular less professional providers could benefit from a system that has a central data center to compare and contrast images of the lesions and additional patient ⁴Smallpox: Clinical and Epidemiologic Features, D. A. Henderson, Johns Hopkins Center for Civilian Biodefense Studies, Baltimore, Md., USA http://www.cdc.gov/ncidod/EID/vol5no4/henderson.htm information, with the characteristics of the diseases and with information of other patients examined at the same time at other areas or nearby.

### BRIEF DESCRIPTION OF THE DRAWINGS

A better understanding of the present invention can be obtained when the following detailed description of one exemplary embodiment is considered in conjunction with the following drawings, in which:

FIG. 1 is a system block diagram of the described system according to an exemplary embodiment of the invention;

### DESCRIPTION OF THE PREFERRED EMBODIMENTS

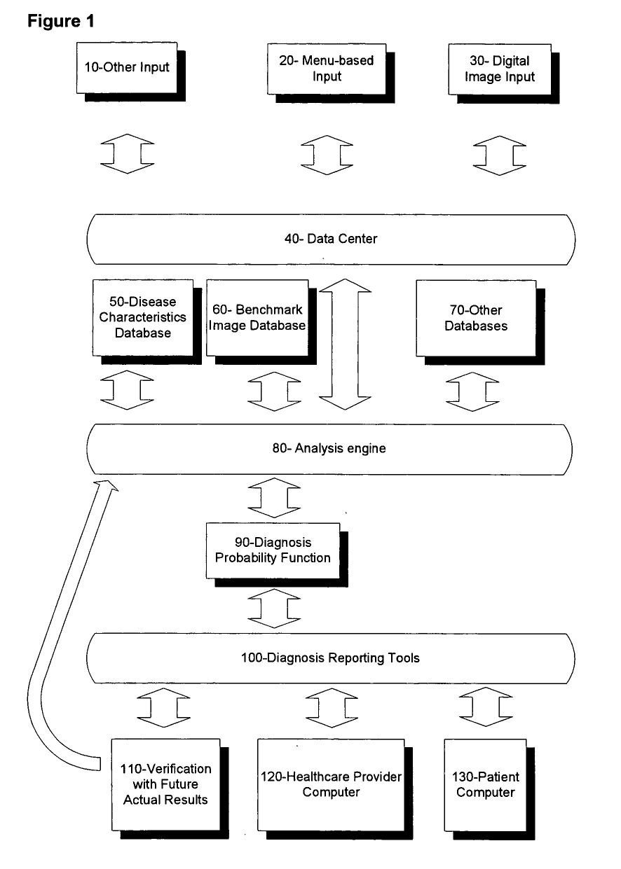

FIG. 1 illustrates the block diagram of the computer aided process and system according to the present invention.

The system described in FIG. 1 may be implemented by hardware specifically designated to implement the present invention or by using infrastructure that already exists.

As an example, the connection between the location of the information entry might be connected to the data center through methods such as Internet connections, closed circuit connections, or direct lines. The computer system for data entry might utilize specially designed cameras and computers, or existing technologies, such as the preferable embodiment utilizing a mobile light computers such as Palm Pilot, Tablet PC or Pocket PC, connected to a compatible camera.

The inputs on both components 10, 20 and 30 could be made via many different information entry-computer systems.

The information entry-computer system, as well as the central computer includes a central processing unit (CPU) for performing processing functions. The computer system also includes a Read Only Memory (ROM) and a Random Access Memory (RAM). The ROM stores at least some of the program instructions that are to be executed by the CPU, and the RAM provides for temporary storage of data. Clock provides a clock signal required by the CPU.

Input to the system could include digital images of skin or other body tissues, as well as answers to questions based on menu selection, or open questions. Other relevant information could be entered to the system; for example, patient specific medical history results from other databases that may have relevance. For example, past blood results.

A communication port facilitates communication between the CPU and devices external to the data entry computer system, such as communication between a modem and the CPU. Information between CPU and remote locations such as the central data center computer system and the information entry computer system is sent via modem.

This embodiment described implements a modem to communicate with devices outside the information entry-computer system; however, other methods of communicating with external devices may be used without departing from the spirit of the invention, including, but not limited to, wireless communications and optical communications.

The term CPU, as generally used herein, refers to any logic processing unit, such as on or more microprocessors, application-specific integrated circuits (ASIC), and the like. While the CPU is described separated from other components such as the ROM, some or all of these components may be monolithically integrated onto a single chip.

Any number of information entry computer systems could be connected to the central computer system. The entry computer system includes a CPU, ROM, RAM, and a clock. The computer system also includes an input/output (I/O) device to communicate with the patient and the medical provider. A wide variety of I/O devices can be implemented for this task, including, but not limited to, a touch screen, a keyboard and a mouse. The I/O device may be linked to the CPU directly or via an intermediate connection, such as an infra-red transmitter and receiver.

One of the data sources (illustrated as item 30 in diagram 1) can be an image of the patient, which may include a picture of a skin lesion or of internal organs. Digital images can be image units such as digital radiography, CT (computed tomography), MR (magnetic resonance imaging), or DELM (digital epiluminescence microscopy). The image could also be a result of data acquisition of a regular CCD image, or a scanned picture.

Additional patient data is entered using a template-based menus of questions, or using natural language (illustrated by item 20 on diagram 1).

While the above description distinguishes between the data sources, they might be entered via the same input computer, for example, by a Pocket PC with a CCD camera connected to it.

The information entered via the multiple sources is transmitted to a central computer system for analysis (illustrated by item 40 on diagram 1), or is being analyzed by a software program located on the local computer system.

The information could be transmitted over any potential network, such as the internet to the central computer. Any suitable communication link which permits electronic communications could be used, including cellular network, wide area networks, satellite and radio links. The transmission can also refer to any suitable communication system for sending messages between remote locations, directly or via a third party communication provider.

The information transmitted is then being analyzed by diagnostic software. The main mechanism of analysis is the comparison of the image, coupled with the additional information, with a database of known characteristics of the analyzed disease. Such database may include images of other patients, a well as historical information of the patient.

The digital image can utilize computerized version of known algorithms for the analysis of skin images. For example, for the analysis of Melanoma, a computerized version of the ABCD algorithms can be utilized for DELM images.

In addition to the utilization of commonly used manual medical methodologies, mechanisms of comparing images to a common database of benchmark images have been utilized for other purposes, and these methodologies could be used for the analysis. These items are illustrated on diagram 1 as a disease characteristic data base (item 50), a benchmark image database (item 60) and other databases (item 70), which are used for the analysis (illustrated as item 80).

Methods such as Principal Components Analysis could be used for the comparison of a digital image sent to the central computer. Principal Components Analysis (PCA) is an ordination technique which involves an eigenanalysis of the correlation matrix or the covariance matrix. PCA is available in most statistical packages, and is often considered a form of “factor analysis”. Its main application are: (1) to reduce the number of variables and (2) to detect structure in the relationships between variables in order to classify variables. The application of principal component analysis are known to those skilled in the art and could be applied in the context of medical images based automated digital analysis. Other methods, known to those skilled in the art, could be utilized. Such methods include for example neutral networks.

The information from the digital images, coupled with the additional patient specific information, can be referenced against existing databases using Bayesian approach to the diagnosing of diseases, for example the software GIDEON, known to those skilled in the art.

Following an analysis of the patient specific input with the database, utilizing the algorithms, an output is a probability, or other indication representing the likelihood of a disease. Such output is a result of a diagnosis probability function (item 90 in diagram 1). The reporting of the results is made using a various of potential reporting tools, illustrated by item 100 on the diagram. For example, standard Crystal report, known to those skilled in the art, can be printed from a data base storing the results. An email tool such as Microsoft Outlook can be used to send an email to the patient computer (illustrated by item 130 on diagram 1), or a related healthcare provider computer (illustrated by item 120 on diagram 1).

As illustrated above, following the analysis, a predictive probability is derived for the image sent by the patient. That predictive probability reflects the likelihood of the patient to have or to develop the diagnoses disease. For example, the likelihood of the skin image to document a dysplastic nevi or malignant melanoma.

That predictive probability is adjusted by the additional information provided by the patient or stored in his or her patient file at the central computer. For example, those who have dysplastic nevi and a family history of dysplastic nevi and melanoma have more than a 50% risk of developing melanoma by the age of 60. Others who have dysplastic nevi but not such a strong family history of melanoma have an estimated lifetime risk of melanoma of 6%.

The software used for the diagnosis could be enhancing its performance over time, as it incorporates the images and diagnosis of new patient information being diagnosed. That information, identified by the patient identifier enhance the detection ability, by comparing images from the same patient over time. In addition, the results could be improved by comparing the diagnosis to results by follow ups reported by the healthcare worker. An illustration of this mechanism is in item 110 on diagram 1, where the results of the algorithm are being fed back to the analysis engine (item 80), via which they could also be stored in other databases (item 70).

The image and additional entered information can be connected to additional stored information. For example, surveillance information from a national surveillance system of the CDC and the department of Defense (DOD) can be added, to better enhance the accuracy of the diagnostic. Such a system, combining information from multiple sources, is superior to an analysis based only on the analysis of the digital image. Such databases are represented by item 70 on diagram 1.

The results of the forecasts are then stored for comparison with additional diagnostic, provided by medical professionals or by other techniques. That comparison, is allowing for the calibration of the process, based on the accuracy level of the alternative methodologies.

It should be understood the processes described are only exemplary and any suitable permutation of the processes may be used.

The foregoing disclosure and description of the invention are illustrative and explanatory thereof and various changes to the size, shape, materials, components, and order may be made without departing from the spirit of the invention.

While the present invention has been described with reference to the disclosed embodiments, it is to be readily apparent to those of ordinary skill in the art that changes and modifications to the form in details may be made without departing from the spirit and scope of the invention.

We claim:

1. A medical system comprising:
at least one source of an optical or digital image of an examination subject;
a computer for processing said image and for entering additional patient-related data;
a communication system connected to said computer for transmitting said medical image and said patient-related data to a location remote from said work station;
a storage unit connected to said communication system for storing said medical image and said additional patient data;
a computer software to determine the level of similarity between said image and additional patient-related data to the characterization of specific diseases and additional historical and current information;
a computer program to determine the probability that the patient has a disease characterized by the computer software;
a computer program to report the results and store them;

2. Thee method of claim 2 wherein the computer software also compare the above forecasts with forecasts made by other means and to actual future realizations and to calibrate the above computer program to prior misclassifications;

3. A method for using a computer to facilitate a computer aided diagnosis, comprising: inputting into an input device at least one digital image;
inputting into the computer of an identifier specifying a patient account, the identifier being associated with a digital image from a patient body;
outputting the digital image to at least one computer system after receiving the identifier;
inputting into the computer a computerized diagnosis based on the digital image, and;
providing the sender the diagnosis using the patient identifier.

4. A method for providing a predictive probability of a patient having a disease, comprising the steps of:
receiving on a local computer a patient information signal by a central facility system means, the patient information package being related to a selected patient and composed of a plurality of information sources, including at least one medical image;
transmitting the patient information package over a network into the central computer system;
assigning a predictive probability to the patient information package by a computer program at the central computer based on at least one component of the patient information package, a disease to be diagnosed, a database of risk factors of that disease, computed or manually extracted from a database containing a plurality of previously obtained individualized patient information records;
transmitting the patient predictive probability signal to a local computer means;

5. The method of claim 4 wherein the patient predictive probability is provided along with a corresponding recommendation signal by the central facility system that is based on the association of the predictive probability and a table of recommendations.

6. the method of claim 4 wherein the predictive probability is sent to the patient
